(19) United States
(12) Patent Application Publication
(10) Pub. No.: US 2012/0054071 A1
(43) Pub. Date: Mar. 1, 2012

(54) OPTIMIZING PURCHASE ORDER PROCESSING FOR LEARNING MANAGEMENT SYSTEM (LMS) COURSE

(75) Inventors: CHARLES W. GRIFFIN, Davenport, IA (US); MARLA A. HADDON, Newnan, GA (US)

(73) Assignee: INTERNATIONAL BUSINESS MACHINES CORPORATION, Armonk, NY (US)

(21) Appl. No.: 12/872,561

(22) Filed: Aug. 31, 2010

(51) Int. Cl. G06Q 30/00; G09B 7/00

(52) U.S. Cl. 705/26.81; 434/322

(57) ABSTRACT

A system and associated method for optimizing process of a purchase order of a Learning Management System (LMS) course for at least one student. The method creates a course data file from a course record stored in a database, and an order data file from an applicant order for a purchase of the LMS course. The course record and the applicant order are associated via a sale course code that represents specifics of the purchase of the LMS course. A quantity of the applicant order indicates a number of students for whom the LMS course purchased. If the quantity is greater than one, an access code is created for an interactive enrollment by each student in the applicant order. Even if the quantity is one, when a student e-mail address is not provided, the access code is produced to enable the individual student to interactively enroll in the LMS course.

### CROSS-REFERENCE TO RELATED APPLICATION

This invention is related to U.S. patent application Ser. No. ______ (Attorney Docket No. END920090046US1) entitled “AUTOMATED USER REGISTRATION AND COURSE ENROLLMENT IN LEARNING MANAGEMENT SYSTEM (LMS)”, filed on Aug. 31, 2010.

### BACKGROUND OF THE INVENTION

The present invention discloses a system and associated method for optimizing purchase order processing for Learning Management System (LMS) course. In conventional learning management systems, purchase order is manually processed for registration, enrollment and confirmation, which is labor intensive and inefficient.

### BRIEF SUMMARY

According to one embodiment of the present invention, a method for optimizing process of a purchase order of a Learning Management System (LMS) course for at least one student. The method comprises: a processor of a computer system creating a course data file comprising at least one course record stored in a database coupled to the computer system, wherein a course record of said at least one course record comprises a sale course code and a delivery course code, the sale course code representing a learning management system (LMS) course in the purchase order, said delivery course code representing the LMS course in a training session as provided by a LMS server; generating an order data file comprising at least one applicant order, said at least one applicant order comprises the purchase order, wherein an applicant order of said at least one applicant order comprises a sale course code, a manager e-mail address, and a quantity, the sale course code representing the LMS course purchased by the applicant order, the manager e-mail address representing an e-mail address of a manager of said at least one student, the quantity representing a number of licenses to attend the LMS course that is purchased by the applicant order, wherein the applicant order is mapped to the course record in the course data file, wherein a first value of the sale course code of the applicant order is identical to the sale course code of the mapped the course record; producing an access code for the applicant order, the access code enabling said at least one student to interactively enroll in the LMS course; and communicating the access code to the manager e-mail address of the applicant order such that the access code is forwarded to said at least one student.

According to one embodiment of the present invention, a computer program product comprises a computer readable memory unit that embodies a computer readable program code. The computer readable program code contains instructions that, when run by a processor of a computer system, implement a method for optimizing process of a purchase order of a Learning Management System (LMS) course for at least one student.

According to one embodiment of the present invention, a computer system comprises a processor and a computer readable memory unit coupled to the processor, wherein the computer readable memory unit containing instructions that, when run by the processor, implement a method for optimizing process of a purchase order of a Learning Management System (LMS) course for at least one student.

According to one embodiment of the present invention, a process for supporting computer infrastructure, said process comprising providing at least one support service for at least one of creating, integrating, hosting, maintaining, and deploying computer-readable code in a computing system, wherein the code in combination with the computing system is capable of performing a method for optimizing process of a purchase order of a Learning Management System (LMS) course for at least one student.

### BRIEF DESCRIPTION OF THE SEVERAL VIEWS OF THE DRAWINGS

FIG. 1A illustrates a system 10 for optimizing purchase order processing for a Learning Management System (LMS) course, in accordance with embodiments of the present invention.

FIGS. 1B, 1C and 1D illustrate data elements of various databases within the system for optimizing purchase order processing for a Learning Management System (LMS) course of FIG. 1A, in accordance with the embodiments of the present invention.

FIG. 2 is a flowchart depicting a method for optimizing purchase order processing for a Learning Management System (LMS) course, as performed by the registration optimizer 41 of FIG. 1, in accordance with the embodiments of the present invention.

FIG. 3 is a flowchart depicting step 110 of the method for optimizing purchase order processing for a Learning Management System (LMS) course of FIG. 2, wherein step 110 is performed by the database server 20 of FIG. 1, in accordance with the embodiments of the present invention.

FIG. 4 is a flowchart depicting step 120 of the method for optimizing purchase order processing for a Learning Management System (LMS) course of FIG. 2, wherein step 120 is performed by the internal application server 30 of FIG. 1, in accordance with the embodiments of the present invention.

FIG. 5 is a flowchart depicting step 130 of the method for optimizing purchase order processing for a Learning Management System (LMS) course of FIG. 2, wherein step 130 is performed by the application server 40 of FIG. 1, in accordance with the embodiments of the present invention.

FIG. 6 is a flowchart depicting a method for processing order data, in step 440 of FIG. 5, as performed by the application server, in accordance with the embodiments of the present invention.

FIG. 7A illustrates a first screen display for administration of the learner portal server shown by an access code, wherein an administrator adds a new course or deletes an existing course, in accordance with the embodiments of the present invention.

FIG. 7B illustrates a second screen display for administration of the learner portal server, which is linked to the Course Number of the first screen display of FIG. 7A, wherein the administrator edits course information comprising fields for access code, organization, course description, max user, start date and end date, in accordance with the embodiments of the present invention.

FIGS. 7C and 7D illustrate an example welcome message generated by the application server in step 460 of FIG. 5, in accordance with the embodiments of the present invention.

FIG. 7E illustrates an example of a user login page to the learner portal server that is hyperlinked to the Uniform Resource Locator (URL) displayed in the welcome message, in accordance with the embodiments of the present invention.

FIG. 8 illustrates a computer system used for optimizing purchase order processing for a Learning Management System (LMS) course, in accordance with the embodiments of the present invention.

### DETAILED DESCRIPTION

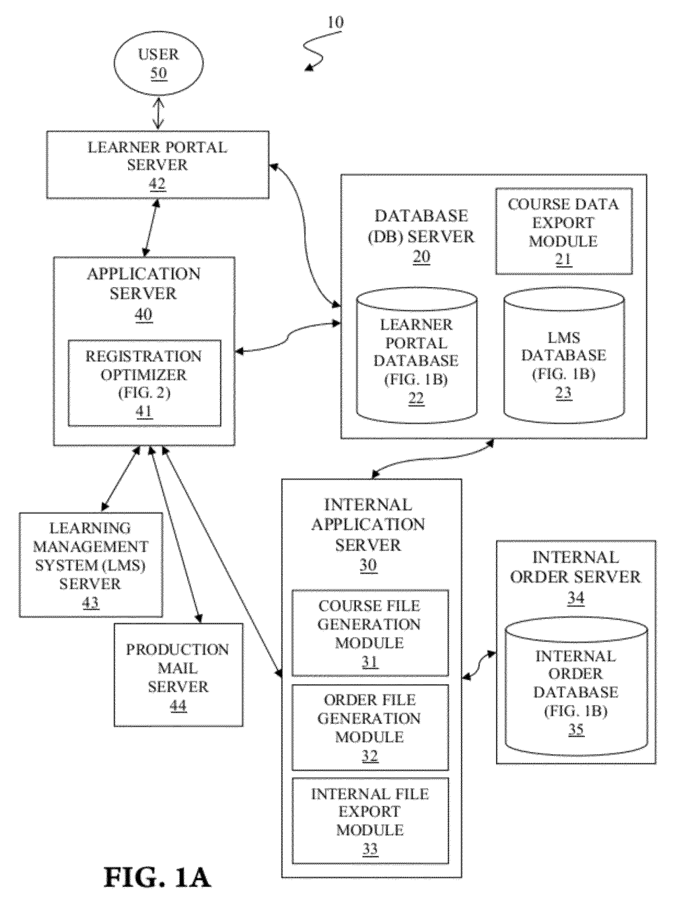

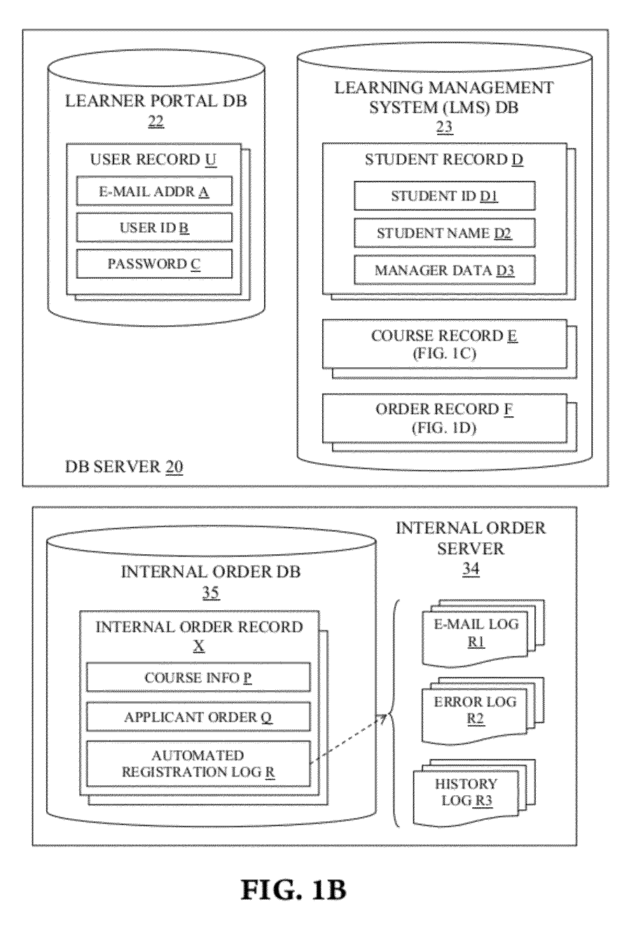

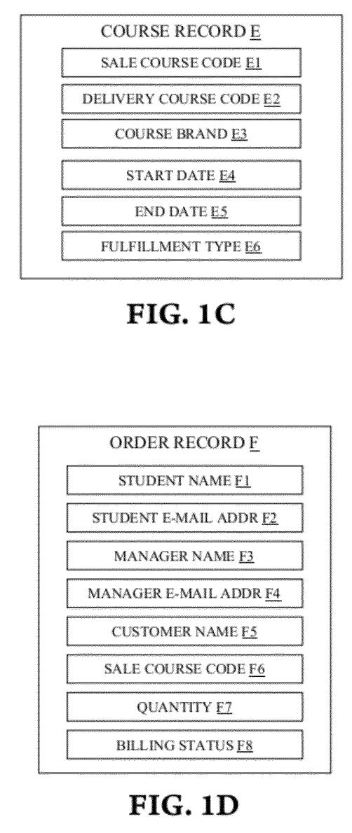

FIG. 1A illustrates a system 10 for optimizing purchase order processing for a Learning Management System (LMS) course, in accordance with embodiments of the present invention.

The system 10 comprises a database server 20, an internal application server 30, an internal order server 34, an application server 40, a learner portal server 42, a learning management system (LMS) server 43, and a production mail server 44. A user 50 accesses the system 10 through the learner portal server 42. In this specification, the terms user, applicant, and student interchangeably indicates the user 50 of the system 10. Each component of the system 10 may refer to the user 50 accessing a respective component with a respective term. In this specification, registration to a course indicates that the user 50 is enlisted in the learner portal server 42 with a corresponding user record and enlisted in a specific course provided by the LMS server 43 according to a purchase order.

The database server 20 comprises a course data export module 21, a learner portal database 22, and a learning management system (LMS) database 23. See FIG. 1B, infra, for data components of the learner portal database 22 and the LMS database 23. The database server 20 stores data to and from the internal application server 30, the application server 40, and the learner portal server 42.

One embodiment of the learner portal database 22 utilizes a Lightweight Directory Access Protocol (LDAP), which is a session-based protocol for querying and modifying data using directory services running over Transmission Control Protocol/Internet Protocol (TCP/IP) of the Internet Protocol suite. See Request for Comments (RFC) 4510 published by the Internet Engineering Task Force (IETF) for technical specifications of LDAP.

The internal application server 30 comprises a course file generation module 31, an order file generation module 32, and an internal file export module 33. The internal application server 30 exclusively accesses the internal order server 34, which manages an internal order database 35 to handle order data internally within a domain in which the system 10 operates. See FIG. 1B, infra, for data components of the internal order database 35. The internal order server 34 provides a course code translation service and an access code service for the registration optimizer 41. The internal order server 34 course code translation service maps a first course code used in a purchase transaction to a second course code that will be used in a delivery of a purchased course among course code attributes of various database records. The access code service facilitates a user to register multiple students to a course in one purchase transaction, or to add available course selection over time. See descriptions of FIG. 4, infra, for details of services provided by the internal order server 30.

The database server 20, periodically and/or upon update of respective records in the various databases, synchronizes relevant data component data stored in the internal order database 35, the learner portal database 22, and the LMS database 23.

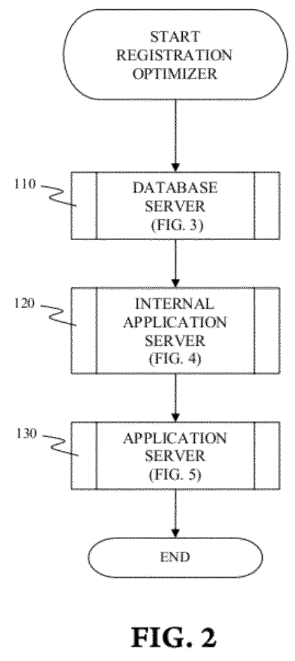

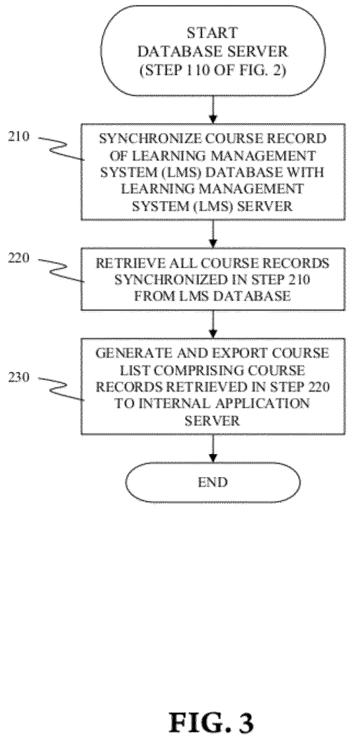

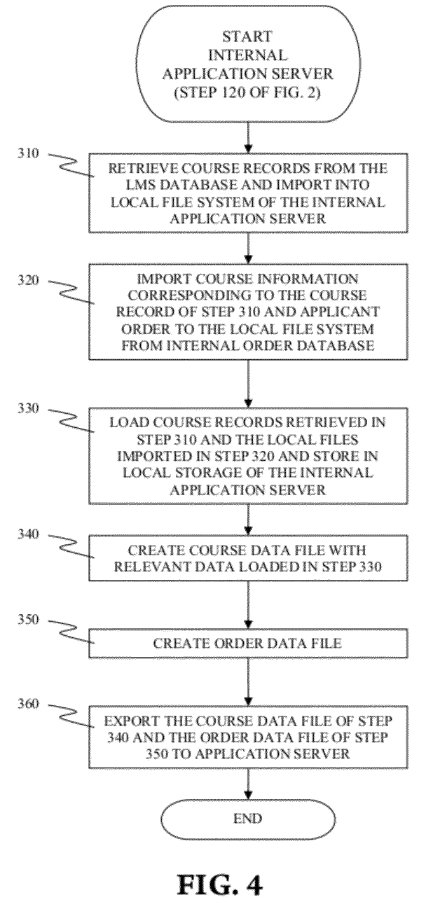

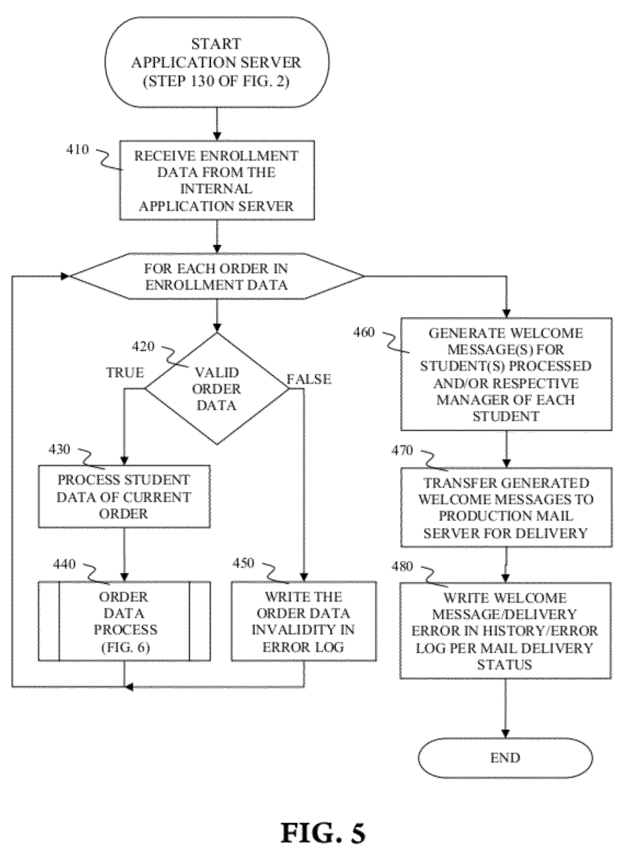

The application server 40 comprises a registration optimizer 41, which optimizes enrollment of the user 50 in at least one LMS course provided by the LMS server 43. In this specification, to enroll the user 50 in a LMS course, the user 50 must be registered with the learner portal server 42. Wherein the course enrollment is described, the user 50 is presumed to be previously registered with the learner portal server 42. See FIG. 2, infra, for steps performed by the registration optimizer 41.

The learner portal server 42 is also used as a user interface for the user 50 to access the LMS server 43 for attendance of courses that the user 50 has been enrolled either automatically by the application server 40 or interactively after the user 50 accesses the learner portal server 42 with an access code.

The application server 40 utilizes the LMS server 43 to actually enroll the user 50 to a course requested by the user 50, wherein the course is provided by the LMS server 43 and wherein all data of the course is available by use of the database server 20. In this specification, the learning management system (LMS) server 43 is also referred to as a production system as the learning management system (LMS) renders on-line education services.

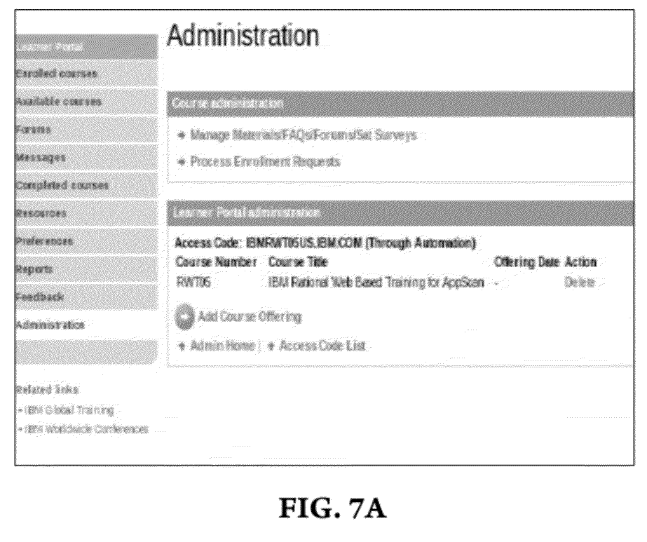

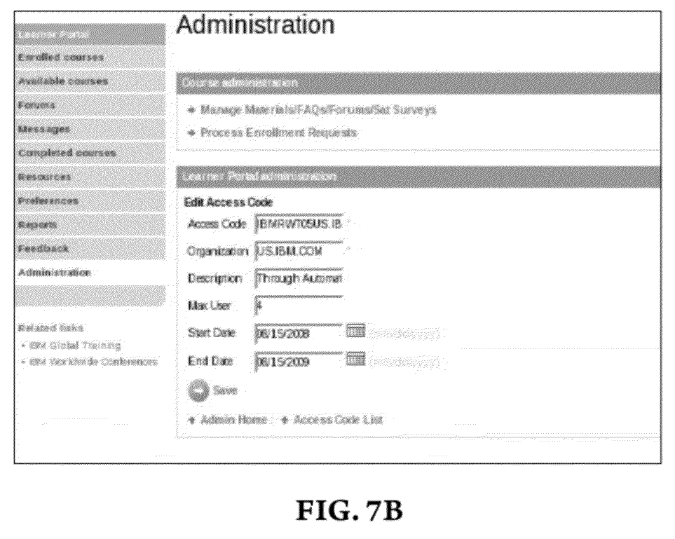

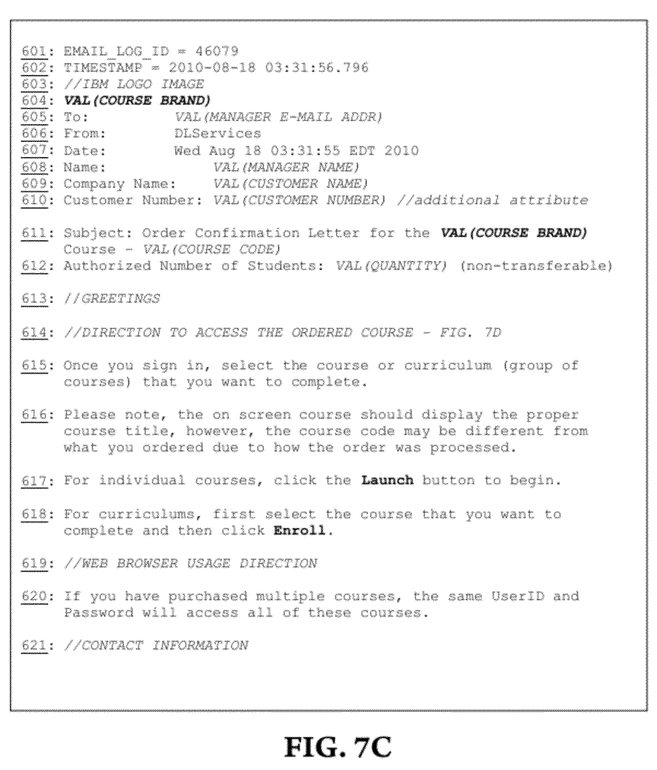

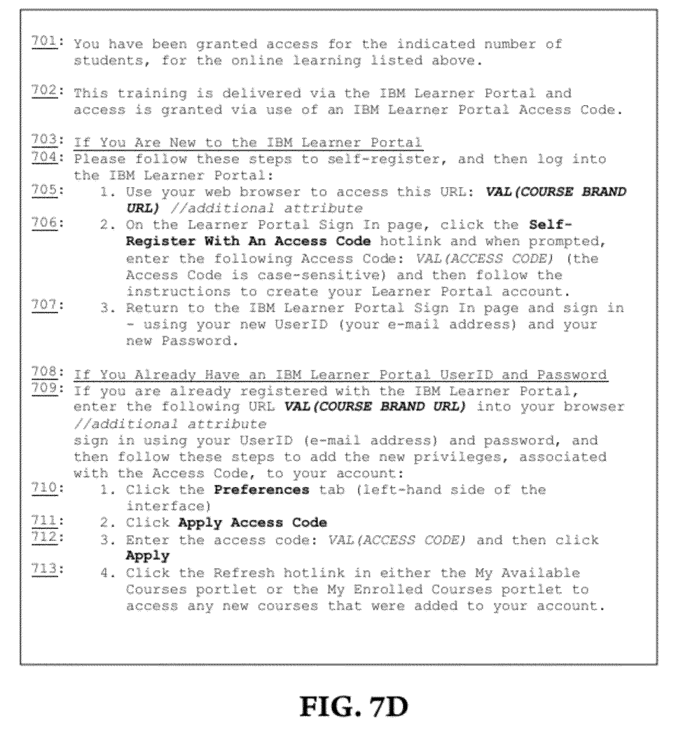

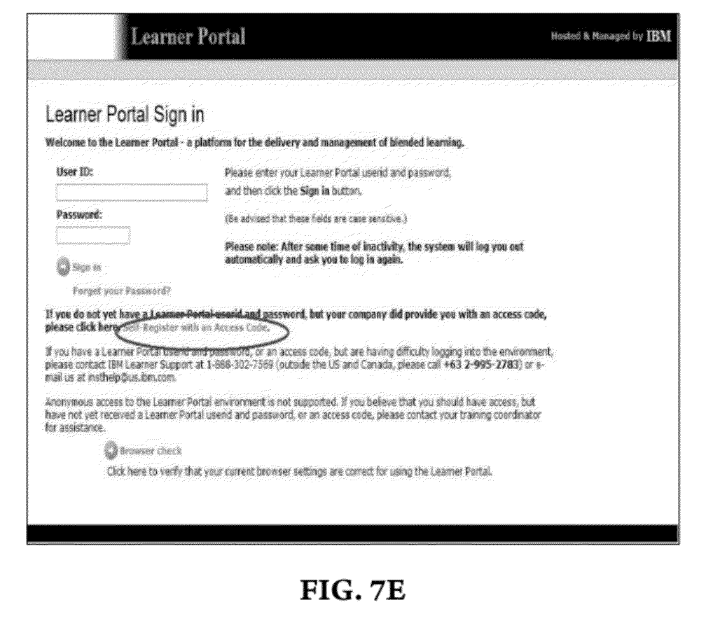

The application server 40 utilizes the production mail server 44 to deliver a welcome message to notify completion of registry information and to provide a login link to the user 50 of the system 10. See descriptions of FIGS. 7C and 7D, infra, for examples of welcome messages generated by the application server 40.

FIGS. 1B, 1C and 1D illustrate data elements of various databases within the system for optimizing purchase order processing for a Learning Management System (LMS) course of FIG. 1A, supra, in accordance with the embodiments of the present invention.

FIG. 1B illustrates a respective data structure of the learner portal database 22, the learning management system (LMS) database 23, and the internal order database 35 of the system 10 of FIG. 1A, supra, in accordance with the embodiments of the present invention.

The learner portal database 22 comprises at least one user record, wherein a user record U of said at least one user record represents a respective user of the system. The user record U comprises attributes of e-mail address A, user identifier (ID) B, and password C. The e-mail address A attribute contains an electronic mailing address provided by the user 50 of FIG. 1A, supra, with which the system 10 communicates with the user. The user ID B attribute contains an alphanumeric value uniquely identifies the user within the system 10. The password C attribute stores a password for the user corresponding to the user ID B to gain access to the system 10 through a user interface provided by the learner portal server 42 of FIG. 1A, supra.

The LMS database 23 comprises at least one student record, at least one course record, and at least one order record. Each student record of said at least one student record corresponds to a respective student who is currently registered with the LMS server 43 of FIG. 1A, supra. Each course record of said at least one course record corresponds to a respective course provided by the LMS server. Each order record of said at least one order record corresponds to a respective order placed with the LMS server.

A student record D of said at least one student record comprises attributes of student identifier (ID) D1, student name D2, and manager data D3. The student ID D1 is a key that uniquely identifies each student record of said at least one student record of the LMS database 23. The student record D is associated with the user record U of the learner portal database 22, if the student ID D1 has a data value identical to the data value of the user ID B of the user record U. The student name D2 is a name of a student identified by the student ID D1. The manager data D3 comprises information identifying a training coordinator and/or a human resource (HR) manager who is responsible for the student of the student record D.

FIG. 1C illustrates attributes of a course record E of said at least one course record in the LMS database, in accordance with the embodiments of the present invention.

The course record E comprises attributes of sale course code E1, delivery course code E2, course brand E3, start date E4, end date E5, and fulfillment type E6, as illustrated in.

The sale course code E1 is an alphanumeric value identifying an on-line learning course that is offered by the LMS server 43 of FIG. 1A, supra. The sale course code E1 uniquely identifies the on-line learning course that is being ordered in a purchase transaction. In the purchase transaction, the user purchases the on-line learning course that is identified by the sale course code E1. The user in the purchase transaction may be an individual student who will take the on-line learning course or a company representative ordering the on-line learning course for more than one student.

The delivery course code E2 is an alphanumeric value that identifies an instance of the on-line learning course software program referred to as courseware, which is delivered through the learner portal server 42 of FIG. 1A, supra. In each course record of said course record in the LMS DB 23, the delivery course code E2 may correspond to multiple instances of sale course codes in respective course records, because the on-line learning course provided by the LMS server may be offered in various circumstances of the purchase transaction. Examples of factors that necessitate different sale course code for the same on-line learning course to be delivered may be, inter alia, discount applied the purchase, a country of the purchaser, etc.

The course brand E3 indicates a subject matter of the courseware that is represented by the delivery course code E2.

The start date E4 represents a first date when the courseware will be made available by the LMS server. The end date E5 represents a second date when the courseware will expire such that the user cannot use the courseware after the second date.

The fulfillment type E6 indicates which fulfillment methodology/logic path is to be used in processing an order made for the sale course code E1. A fulfillment methodology describes how to determine the purchase transaction is fulfilled in the process of purchase and delivery of the on-line learning course. Examples of factors affecting the determination of fulfillment may be, inter alia, payment approval by the user and subsequent notification by the LMS server, automatic fulfillment without notification once confirmation number is issued, etc.

FIG. 1D illustrates attributes of an order record F of said at least one order record in the LMS database, in accordance with the embodiments of the present invention.

The order record F of said at least one order record comprises attributes of student name F1, student e-mail address F2, manager name F3, manager e-mail address F4, customer name F5, sale course code F6, quantity F7, and billing status F8.

The student name F1 is a character string that represents a name of a student who takes the course. The student name F1 of the order record F is mapped to the student name D2 of the student record D. The student e-mail address F2 is an e-mail address associated with the student name F1 such that the application server and/or the LMS server uses the student e-mail address F2 to communicate with the student represented by the student name F1.

The manager name F3 is a character string that represents a name of a manager/training coordinator of the student of the student name F1. The manager e-mail address F4 is an e-mail address associated with the manager name F3 such that the application server and/or the LMS server uses the manager e-mail address F4 to communicate with the manager/training coordinator. At least one of the student e-mail address F2 and the manager e-mail address F4 must be provided for the registration optimizer.

The customer name F5 represents the company or institution with which the student of the student name F1 is affiliated. In cases the student is not affiliated with any organization, the customer name F5 is null. The sale course code F6 identifies an on-line learning course requested in the order represented by the order record F. The sale course code F6 is mapped to the sale course code E1 of the course record E such that the order represented by the order record F associates course description with the order. The quantity F7 indicates a number of seats and/or licenses ordered for the on-line learning course of the course code F6. The quantity F7 indicates how many instances/threads of the courseware providing the on-line learning course have been purchased by the order represented by the order record F. The billing status F8 indicates whether the order was paid for.

Referring back to FIG. 1B, the internal order database 35 comprises at least one internal order record, which represents a respective order within the internal application server 30 of FIG. 1A, supra. The internal order database 35 resides within a local storage of the internal application server 30 of FIG. 1A, supra. An ordered course is identified by the sale course code attribute of an order record stored in the LMS database 23, wherein the order record is selected for processing by the internal order server 34.

An internal order record X of said at least one internal order record comprises attributes of course information P, applicant order data Q, and automated registration log R. The course information P comprises a course code that identifies an ordered course, which corresponds to a unique order record from the LMS database 23. The course code of the course information P is mapped to the sale course code attribute of the order record that corresponds to the ordered course. The course information P further comprises a calendar schedule of the course, which is based on start date E4 and end date E5 attributes of the course record E.

The applicant order data Q comprises attributes of applicant name, applicant e-mail address, manager name, manager e-mail address, customer name, sale course code, quantity and the billing status, which respectively corresponds to a respectively corresponding attribute of said at least one order record of the LMS database 23, wherein the applicant name and the applicant e-mail address of the internal order database correspond to the student name and the student e-mail address of the order record of the LMS database.

The automated registration log R records information generated by the application server 40 of FIG. 1A, supra, during the registration optimizing of at least one order purchasing the on-line training course. The automated registration log R comprises attributes of e-mail log R1, error log R2, and history log R3. The e-mail log R1 contains a copy of all order fulfillment letters/welcome messages, which were sent to students and/or managers by the production mail server 44 of FIG. 1A, supra. The error log R2 contains information related to all orders that the system 10 of FIG. 1A, supra, had failed to automatically register with the LMS server 43 of FIG. 1A, supra. The history log R3 contains information related to all orders that the system 10 of FIG. 1A, supra, had succeeded in automatically registering with the LMS server 43 of FIG. 1A, supra.

Because web-based online learning materials are provided to customers as a part of consumable assets in commercial software packages, a process enrolling the customers for accessing such online learning materials needs to be optimized to service various leaning materials to multiple customers. Examples of software packages utilizing customer enrollment may be, inter alia, Rational®, WebSphere®, Lotus®, Tivoli® systems provided by IBM® (IBM, Rational, WebSphere, Lotus, and Tivoli are registered trademarks of International Business Machines, Corp. in the United States and/or other countries.)

In this embodiment, since the learner portal server 42 is web-based, the registration optimizer 41 of the application server 40 enrolls internal and external users of the system 10. In this specification, the internal users refer to a first group of users who access the system 10 from within a domain that hosts the system 10, and the external users refer to a second group of users who access the system 10 out of the domain that hosts the system 10. In conventional system configuration for the system 10, the internal users are ordinarily registered in an internal directory comprising a respective record associated with each internal user and/or a group of internal users stored within the system 10. In this specification, the term “directory” is defined as a set of objects with attributes organized in a logical and hierarchical manner. An example of a directory may be, inter alia, a telephone directory that comprises a list of subscriber names organized alphabetically, wherein each subscriber name in the list is associated with a respective address and a respective phone number.

The external users of conventional software packages are not registered in the internal directory, and accordingly do not have associated records within the system 10. Thus, the external users are typically registered through a manual process to use the online learning materials, which is labor-intensive and error-prone. The registration optimizer 41 of the external users are applicable to any enterprise-scale learning management system solutions, in which external customers should be able to access learning materials in a manner similar to that is available to the internal users.

In this embodiment, the system 10 utilizes the registration optimizer 41 of FIG. 1A, supra, throughout the registration process for all internal users and external users and to maximize efficiency of the registration process. By using conventional database synchronization technologies, the system 10 ensures data consistency among the learner portal database 22, the LMS database 23, and the internal order database 35. Particularly, the registration optimizer 41 of FIG. 1A, supra, ensures data consistency between user records of the learner portal database 22 and respectively associated student records of the LMS database 23 based on the common value shared between the user ID attribute of the user records and the student ID attribute of the student records. Similarly, the registration optimizer 41 of FIG. 1A, supra, also ensures data consistency between order records of the LMS database 23 and respectively associated internal order records of the internal order database 35 based on the common value shared between the sale course code of the course records and the sale course code of the order records. As a result, the registration optimizer 41 improves quality of on-line learning service for the users and optimizes performance of the system 10.

FIG. 2 is a flowchart depicting a method for optimizing purchase order processing for a Learning Management System (LMS) course, as performed by the registration optimizer 41 of FIG. 1, supra, in accordance with the embodiments of the present invention.

In step 110, the registration optimizer invokes the database server to synchronize course records in the database server with the LMS server and to prepare a course list for processing of the internal application server and the application server. See descriptions of FIG. 3, infra, for details of step 110.

In step 120, the registration optimizer invokes the internal application server to prepare a course data file and an order data file for the application server based on local filed imported from the database server. See descriptions of FIG. 4, infra, for details of step 120.

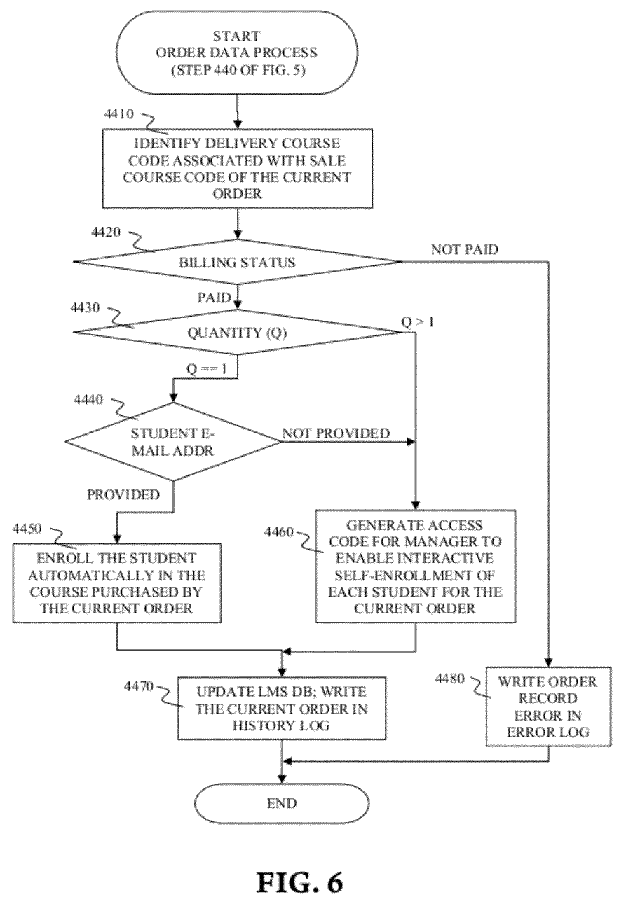

In step 130, the registration optimizer invokes the application server to process each order for enrollment and to generate welcome messages to each applicant and relevant personnel. See descriptions of FIG. 5, infra, for details of step 130.

FIG. 3 is a flowchart depicting step 110 of the method for optimizing purchase order processing for a Learning Management System (LMS) course of FIG. 2, supra, wherein step 110 is performed by the database server 20 of FIG. 1, supra, in accordance with the embodiments of the present invention.

In step 210, the database server connects to the Learning Management System (LMS) server, and synchronizes the LMS database with the course records of the LMS server. The database server may comprise a respective database management module for the learner portal database and the LMS database. The database server proceeds with step 220.

In step 220, the database server retrieves all course records stored in the LMS database as synchronized in step 210. The database server proceeds with step 230.

In step 230, the database server generates a course list comprising all course data retrieved from the LMS database in step 220, and exports the generated course list to the internal application server. In one embodiment of the present invention, the database server performs step 230 by use of a separate data export module. The database server terminates and the registration optimizer proceeds with step 120 of FIG. 2, supra.

FIG. 4 is a flowchart depicting step 120 of the method for optimizing purchase order processing for a Learning Management System (LMS) course of FIG. 2, supra, wherein step 120 is performed by the internal application server 30 of FIG. 1, supra, in accordance with the embodiments of the present invention.

In step 310, the internal application server retrieves the course list from the LMS database exported by the database server in step 230 of FIG. 3, supra. The internal application server imports the course list into a local file system of the internal application server. The internal application server proceeds with step 320.

In step 320, the internal application server imports a course schedule and applicant order data that are respectively associated with each course in the course list as local files into the local file system from the internal order database. The internal application server proceeds with step 330.

In step 330, the internal application server loads the course list retrieved in step 310 and the local files imported in step 320 in the local database of the internal application server. The local files comprise respective course schedule and applicant order data for each course in the course list. The internal application server proceeds with step 340.

In step 340, the internal application server creates a course data file comprising sale course code data, delivery course code data, and fulfillment type data. The sale course code data is a data value of the sale course code attribute of the course record, which has been purchased by the student. The sale course code attribute is devised to represent factors to specify characteristics of the order, inter alia, a flag indicating whether or not group discount is applied, from which country the student will attend the purchased course, whether or not the student has a special status for discount, assistance, etc. In contrast with the sale course code attribute, a data value of the delivery course code attribute indicates the course to be delivered to the student through the learner portal server as provided by the LMS server. The fulfillment type data is a data value of the fulfillment type attribute of the course record. In one embodiment of the present invention, the internal application server creates the course data file by use of a separate course file generation module. The internal application server proceeds with step 350.

In step 350, the internal application server creates an order data file. The order data file comprises data of the order records of the LMS database, which are e-mail address, course code and quantity. In one embodiment of the present invention, the internal application server creates the order data file by use of a separate order file generation module. The internal application server proceeds with step 360.

In step 360, the internal application server exports the course data file of step 340 and the order data file of step 350 to the application server. In one embodiment of the present invention, the internal application server exports the course data file and the order data file by use of a separate internal file export module. Then the internal application terminates and the registration optimizer proceeds with step 130 of FIG. 2, supra.

FIG. 5 is a flowchart depicting step 130 of the method for optimizing purchase order processing for a Learning Management System (LMS) course of FIG. 2, supra, wherein step 130 is performed by the application server 40 of FIG. 1, supra, in accordance with the embodiments of the present invention.

In step 410, the application server receives enrollment data from the internal application server, as exported by the internal application server in step 360 of FIG. 4, supra. The enrollment data comprises the course data file generated in step 340 of FIG. 4, supra, and the order data file generated in step 350 of FIG. 4, supra. The application server proceeds with step 420.

The application server performs steps 420, 430, 440, and/or 450 for each order in the enrollment data received in step 410. The application server selects a first order that have not been processed as a current order.

In step 420, the application server determines whether the order data of the current order is properly populated and valid for further registration by examining values of attribute(s) of the current order. Factors affecting validity of the order data may vary based on the functionalities required with the order data. In one embodiment of the present invention, the order data cannot have null for both the student e-mail address attribute and the manager e-mail address attribute to communicate a result from the automated registration and welcome messages. If the application server determines that the order data of the current order is valid for further registration, then the application server proceeds with step 430. If the application server determines that the order data of the current order is not valid for further registration, then the application server proceeds with step 450.

In step 430, the application server processes the student data associated with the current order. The application server proceeds with step 440.

In step 440, the application server processes order data of the student whose user data had been processed in step 430 for enrollment of the student. See descriptions of FIG. 6, infra, for detailed steps of step 440. Then the application server loops back to step 420 after updating the current order with a next order in the enrollment data. Upon processing all order data in the enrollment data, the application server proceeds with step 460.

In step 450, the application server writes, in the error log of the internal order database, the order data error comprising invalid values of the order data for the current order as determined in step 420. Then the loops back to step 420 after updating the current order with a next order that has not been processed yet in the enrollment data. If the current order is the last order in the enrollment data, the application server proceeds with step 460.

In step 460, the application server generates a number of welcome messages for each student enrolled in step 430 and a respective manager of each enrolled student. Wherein two or more students share a same manager, the welcome messages for the manager may be consolidated to reduce traffic. The application server proceeds with step 470.

In step 470, the application server transfers the welcome messages generated in step 460 to the production mail server, which subsequently delivers the welcome messages to a respective student and a respective manager described in step 460. Then the application server proceeds with step 480.

In step 480, the application server finishes the automated registration of the student to the ordered course by checking the delivery status of the welcome message. If the welcome message is successfully delivered to intended recipients, pairs of students and managers, then the application server writes the welcome message in the e-mail log of the internal order database. If the welcome message has not been delivered within a reasonable amount of time, the application server determines that an error had occurred and writes the error in the error log of the internal order database. Then the application server terminates.

FIG. 6 is a flowchart depicting a method for processing order data, in step 440 of FIG. 5, supra, as performed by the application server, in accordance with the embodiments of the present invention.

In step 4410, the application server locates a course record of the current order having a sale course code value of the order record in the enrollment data and, within the located course record, identifies the value of the delivery course code that is associated with the sale course code value. Because one delivery course code may be purchased with more than one sale course code, as described in FIG. 1C, supra, the mapping of the sale course code to the delivery course code enables the application server to identify the on-line training course provided by the LMS server to enroll the student. Then the application server proceeds with step 4420.

In step 4420, the application server determines whether the order was paid by examining the billing status of the order record. If the application server determines that the order was paid, then the application server proceeds with step 4430 to enroll the student in the ordered course. If the application server determines that the order was not paid, then the application server proceeds with step 4490 to record an error with enrolling the student in the course.

In step 4430, the application server examines the quantity of the order record for the current order, as a first condition for automatic enrollment of the student in the ordered course. If the application server determines that the quantity of the current order is one (1), which indicates that the student is an individual, then the application server proceeds with step 4440 to check further whether the student can be automatically enrolled in the ordered course. If the application server determines that the quantity of the current order is greater than one (1), indicating that the student is a group, then the application server proceeds with step 4460 because each student of the group needs to interactively enroll in the course.

In step 4440, the application server determines whether the student e-mail address is provided in the current order, as a second condition for automatic enrollment of the student in the ordered course. If the application server determines that the student e-mail address is provided, which indicates that the student is eligible for automatic enrollment in the course, then the application server proceeds with step 4450. If the application server determines that the student e-mail address is not provided, which indicates that the student, even though an individual student, is not eligible for automatic enrollment in the course, then the application server proceeds with step 4460 for interactive enrollment of the individual student.

In step 4450, the application server enrolls the individual student with the student e-mail address to the course purchased by the current order. During the enrollment, the individual student is automatically registered with the learner portal server, if the learner portal server does not have a user record corresponding to the individual student. See a related patent application noted in section “CROSS-REFERENCE TO RELATED APPLICATION” for details of the direct enrollment steps. Then the application server proceeds with step 4470.

In step 4460, the application server generates an access code for a manager of the order record for the current order to enable actual students to interactively register themselves in the learner portal server and enroll in the purchased course. The access code enables the user to simultaneously purchase the course in multiple quantities, as indicated by the value of the quantity attribute of the order record. When the access code is generated, the purchase order in multiple quantities cannot be associated with actual students because the purchase order may have been placed without the student information, name and e-mail address, in the order record. The application server generates the access code for the manager who places the purchase order in multiple quantities, and when each actual student accesses the purchased course with the access code issued to the manager, the learner portal server registers the student as a user of the learner portal server and authorizes the student to attend the course. See FIGS. 7A, 7B, 7C, 7D, and 7E, infra, for various examples of the access code and the usage of the access code. Then the application server proceeds with step 4470.

In step 4470, the application server updates an order record of the LMS database that corresponds to the current order and writes the current order in the history log of the internal order database, as the current order is successfully processed either by enrolling the individual student in step 4450 or by generating the access code in step 4460. Then the application server terminates processing the current order.

In step 4480, the application server writes the error in the billing status of the order record for the current order into the error log of the internal order database because the current order is not paid for and cannot be further processed. The application server subsequently terminates processing the current order without enrolling the student.

FIG. 7A illustrates a first screen display for administration of the learner portal server shown by an access code, wherein an administrator adds a new course or deletes an existing course, in accordance with the embodiments of the present invention.

FIG. 7B illustrates a second screen display for administration of the learner portal server, which is linked to the Course Number of the first screen display of FIG. 7A, supra, wherein the administrator edits course information comprising fields for access code, organization, course description, max user, start date and end date, in accordance with the embodiments of the present invention.

FIGS. 7C and 7D illustrate an example welcome message generated by the application server in step 460 of FIG. 5, supra, in accordance with the embodiments of the present invention.

In line 601, “EMAIL_LOG_ID” represents a unique identifier of the welcome message within the e-mail log. In line 602, “TIMESTAMP” represents a time value when the welcome message is written into the e-mail log.

In the actual welcome message generated by the application server, VAL(COURSE BRAND) of lines 604 and 611 is instantiated with a value of the attribute “course brand” of the course record for the current order; VAL(MANAGER E-MAIL ADDR) of line 605 is instantiated with a value of the attribute “manager e-mail address” of the order record for the current order; VAL(MANAGER NAME) of line 608 is instantiated with a value of the attribute “manager name” of the order record; VAL(CUSTOMER NAME) of line 609 is instantiated with a value of the attribute “customer name” of the order record; VAL(COURSE CODE) of line 611 is instantiated with a value of the attribute “sale course code” of the order record; and VAL(QUANTITY) of line 612 is instantiated with a value of the attribute “quantity” of the order record.

In this embodiment, the order record further comprises an attribute “customer number” for easier identification of customers, additional to the attribute of “customer name”. VAL(CUSTOMER NUMBER) of line 610 is instantiated with a value of the attribute “customer number” of the order record.

In the welcome message, “//IBM LOGO IMAGE” of line 603 is replaced by a logo image of the LMS provider, in this case, IBM. “//GREETINGS” of line 613 is replaced by a paragraph of personalized greeting with the manager name. “//WEB BROWSER USAGE DIRECTION” of line 623 is replaced by a web browser usage direction based on user's web browser type. “//CONTACT INFORMATION” in line 625 is replaced by regional contact information.

In the actual welcome message generated by the application server, VAL(ACCESS CODE), in lines 706 and 712 of FIG. 7D, is instantiated with a value of the access code generated in step 4460 of FIG. 6, supra. In the same embodiment, the course record further comprises an attribute “course brand URL” to contain a hyperlink to a computer program and/or a web site that provides the course. VAL(COURSE BRAND URL), in lines 705 and 709 of FIG. 7D, is instantiated with a value of the attribute “course brand URL” of the course record.

FIG. 7E illustrates an example of a user login page to the learner portal server that is hyperlinked to the Uniform Resource Locator (URL) displayed in the welcome message, VAL(COURSE BRAND URL) of lines 705 and 709 of FIG. 7D, supra, in accordance with the embodiments of the present invention.

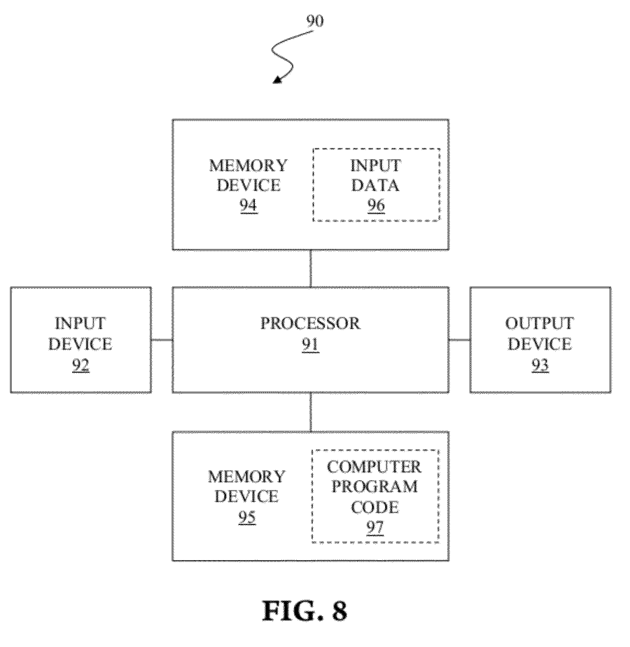

FIG. 8 illustrates a computer system used for optimizing purchase order processing for a Learning Management System (LMS) course, in accordance with the embodiments of the present invention.

The computer system 90 comprises a processor 91, an input device 92 coupled to the processor 91, an output device 93 coupled to the processor 91, and memory devices 94 and 95 each coupled to the processor 91. In this specification, the computer system 90 represents any type of programmable data processing apparatus.

The input device 92 is utilized to receive input data 96 into the computer system 90. The input device 92 may be, inter alia, a keyboard, a mouse, a keypad, a touch screen, a scanner, a voice recognition device, a sensor, a network interface card (NIC), a Voice/video over Internet Protocol (VOIP) adapter, a wireless adapter, a telephone adapter, a dedicated circuit adapter, etc. The output device 93 is utilized to communicate results generated by the computer program code 97 to a user of the computer system 90. The output device 93 may be, inter alia, a printer, a plotter, a computer screen, a magnetic tape, a removable hard disk, a floppy disk, a NIC, a VOIP adapter, a wireless adapter, a telephone adapter, a dedicated circuit adapter, an audio and/or visual signal generator, a light emitting diode (LED), etc.

Any of the components of the present invention can be deployed, managed, serviced, etc. by a service provider that offers to deploy or integrate computing infrastructure with respect to a process for automatically registering applicants to the Learning Management System (LMS) course of the present invention. Thus, the present invention discloses a process for supporting computer infrastructure, comprising integrating, hosting, maintaining and deploying computer-readable code into a computing system (e.g., computing system 90), wherein the code in combination with the computing system is capable of performing a method for automatically registering applicants to the Learning Management System (LMS) course.

In another embodiment, the invention provides a business method that performs the process steps of the invention on a subscription, advertising and/or fee basis. That is, a service provider, such as a Solution Integrator, can offer to create, maintain, support, etc., a process for automatically registering applicants to the Learning Management System (LMS) course of the present invention. In this case, the service provider can create, maintain, support, etc. a computer infrastructure that performs the process steps of the invention for one or more customers. In return, the service provider can receive payment from the customer(s) under a subscription and/or fee agreement, and/or the service provider can receive payment from the sale of advertising content to one or more third parties.

While FIG. 8 shows the computer system 90 as a particular configuration of hardware and software, any configuration of hardware and software, as would be known to a person of ordinary skill in the art, may be utilized for the purposes stated supra in conjunction with the particular computer system 90 of FIG. 8. For example, the memory devices 94 and 95 may be portions of a single memory device rather than separate memory devices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. In this specification, the term “memory device” 94, 95 represents a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium, in contrast to the computer readable storage medium/media, may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency (RF), etc., or any suitable combination of the foregoing.

Computer program code 97 for carrying out operations for aspects of the present invention may be written in any combination of one or more programming languages, including an object oriented programming language such as Java, Smalltalk, C++ or the like and conventional procedural programming languages, such as the “C” programming language or similar programming languages. The computer program code 97 may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. The term “computer program instructions” is interchangeable with the term “computer program code” 97 in this specification. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for optimizing process of a purchase order of a Learning Management System (LMS) course for at least one student, said method comprising:
a processor of a computer system creating a course data file comprising at least one course record stored in a database coupled to the computer system, wherein a course record of said at least one course record comprises a sale course code and a delivery course code, the sale course code representing a learning management system (LMS) course in the purchase order, said delivery course code representing the LMS course in a training session as provided by a LMS server;
generating an order data file comprising at least one applicant order, said at least one applicant order comprises the purchase order, wherein an applicant order of said at least one applicant order comprises a sale course code, a manager e-mail address, and a quantity, the sale course code representing the LMS course purchased by the applicant order, the manager e-mail address representing an e-mail address of a manager of said at least one student, the quantity representing a number of licenses to attend the LMS course that is purchased by the applicant order, wherein the applicant order is mapped to the course record in the course data file, wherein a first value of the sale course code of the applicant order is identical to the sale course code of the mapped the course record;
producing an access code for the applicant order, the access code enabling said at least one student to interactively enroll in the LMS course; and
communicating the access code to the manager e-mail address of the applicant order such that the access code is forwarded to said at least one student.

2. The method of claim 1,
wherein the database comprises a Learning Management System (LMS) database, a learner portal database, and an internal order database,
wherein the LMS database stores said at least one course record, at least one student record, and at least one order record, said at least one student record respectively corresponding to said at least one student, wherein an order record of said at least one order record corresponding to the applicant order is stored in the LMS database,
wherein the learner portal database stores a respective user record corresponding to each student of said at least one student, the respective user record being uniquely identified by a respective user ID identical to a respective student e-mail address of said each student record, wherein the respective student e-mail address is registered by use of the access code,
wherein the internal order database stores at least one internal order record comprising the applicant order and a history log, each internal order record corresponding to a respective order record of said at least one order record stored in the LMS database based on the sale course code of the applicant order, the history log storing the applicant order upon successful completion of said producing the access code, and
wherein the LMS database, the learner portal database, and the internal order database are periodically synchronized by a database server coupled to the processor.

3. The method of claim 1, wherein the sale course code of the course record corresponds to the delivery course code of the course record such that the sale course code of each Learning Management System (LMS) course provided by the LMS server stores a circumstance of the purchase transaction, wherein the circumstance is selected from the group consisting of specifics of discount applied to the purchase transaction, a country from which the purchase transaction originates, and combinations thereof.

4. The method of claim 1, said producing the access code comprising:
ascertaining that the quantity of the applicant order is greater than one (1), which indicates that the applicant order was made for at least two students;
ascertaining that the manager e-mail address of the applicant order is a valid e-mail address of the manager of said at least two students;
rendering the access code based on inputs from an administrator of the LMS server, wherein the access code associates the quantity of the applicant order with the LMS course, the quantity of the applicant order being decreased by one (1) upon each interactive enrollment of an individual student in the LMS course, wherein said each interactive enrollment is selected from the group consisting of registration with the LMS server, enrollment in the LMS course, and combinations thereof;
creating an order record corresponding to the applicant order within the database; and
writing the applicant order in a history log of successfully processed orders within the database.

5. The method of claim 1, said producing the access code comprising:
ascertaining that the quantity of the applicant order is one (1), which indicates that the applicant order was made for an individual student;
ascertaining that a student e-mail address of the applicant order is null and that the manager e-mail address of the applicant order is a valid e-mail address of the manager of the individual student;
rendering the access code based on inputs from an administrator of the LMS server, wherein the access code associates the quantity of the applicant order with the LMS course, the quantity of the applicant order expiring upon an interactive enrollment of the individual student in the LMS course, wherein the interactive enrollment is selected from the group consisting of registration with the LMS server, enrollment in the LMS course, and combinations thereof;
creating an order record corresponding to the applicant order within the database; and
writing the applicant order in a history log of successfully processed orders within the database.

6. A computer program product comprising:
a computer readable storage medium having a computer readable program code embodied therein, said computer readable program code containing instructions that perform optimizing process of a purchase order of a Learning Management System (LMS) course for at least one student, said optimizing comprising:
creating a course data file comprising at least one course record stored in a database coupled to the computer system, wherein a course record of said at least one course record comprises a sale course code and a delivery course code, the sale course code representing a learning management system (LMS) course in the purchase order, said delivery course code representing the LMS course in a training session as provided by a LMS server;
generating an order data file comprising at least one applicant order, said at least one applicant order comprises the purchase order, wherein an applicant order of said at least one applicant order comprises a sale course code, a manager e-mail address, and a quantity, the sale course code representing the LMS course purchased by the applicant order, the manager e-mail address representing an e-mail address of a manager of said at least one student, the quantity representing a number of licenses to attend the LMS course that is purchased by the applicant order, wherein the applicant order is mapped to the course record in the course data file, wherein a first value of the sale course code of the applicant order is identical to the sale course code of the mapped the course record;
producing an access code for the applicant order, the access code enabling said at least one student to interactively enroll in the LMS course; and
communicating the access code to the manager e-mail address of the applicant order such that the access code is forwarded to said at least one student.

7. The computer program product of claim 6,
wherein the database comprises a Learning Management System (LMS) database, a learner portal database, and an internal order database,
wherein the LMS database stores said at least one course record, at least one student record, and at least one order record, said at least one student record respectively corresponding to said at least one student, wherein an order record of said at least one order record corresponding to the applicant order is stored in the LMS database,
wherein the learner portal database stores a respective user record corresponding to each student of said at least one student, the respective user record being uniquely identified by a respective user ID identical to a respective student e-mail address of said each student record, wherein the respective student e-mail address is registered by use of the access code,
wherein the internal order database stores at least one internal order record comprising the applicant order and a history log, each internal order record corresponding to a respective order record of said at least one order record stored in the LMS database based on the sale course code of the applicant order, the history log storing the applicant order upon successful completion of said producing the access code, and
wherein the LMS database, the learner portal database, and the internal order database are periodically synchronized by a database server.

8. The computer program product of claim 6, wherein the sale course code of the course record corresponds to the delivery course code of the course record such that the sale course code of each Learning Management System (LMS) course provided by the LMS server stores a circumstance of the purchase transaction, wherein the circumstance is selected from the group consisting of specifics of discount applied to the purchase transaction, a country from which the purchase transaction originates, and combinations thereof.

9. The computer program product of claim 6, said producing the access code comprising:
ascertaining that the quantity of the applicant order is greater than one (1), which indicates that the applicant order was made for at least two students;
ascertaining that the manager e-mail address of the applicant order is a valid e-mail address of the manager of said at least two students;
rendering the access code based on inputs from an administrator of the LMS server, wherein the access code associates the quantity of the applicant order with the LMS course, the quantity of the applicant order being decreased by one (1) upon each interactive enrollment of an individual student in the LMS course, wherein said each interactive enrollment is selected from the group consisting of registration with the LMS server, enrollment in the LMS course, and combinations thereof;
creating an order record corresponding to the applicant order within the database; and
writing the applicant order in a history log of successfully processed orders within the database.

10. The computer program product of claim 6, said producing the access code comprising:
ascertaining that the quantity of the applicant order is one (1), which indicates that the applicant order was made for an individual student;
ascertaining that a student e-mail address of the applicant order is null and that the manager e-mail address of the applicant order is a valid e-mail address of the manager of the individual student;
rendering the access code based on inputs from an administrator of the LMS server, wherein the access code associates the quantity of the applicant order with the LMS course, the quantity of the applicant order expiring upon an interactive enrollment of the individual student in the LMS course, wherein the interactive enrollment is selected from the group consisting of registration with the LMS server, enrollment in the LMS course, and combinations thereof;
creating an order record corresponding to the applicant order within the database; and
writing the applicant order in a history log of successfully processed orders within the database.

11. A computer system comprising a processor and a computer readable memory unit coupled to the processor, said computer readable memory unit containing instructions that when run by the processor implement a method for optimizing process of a purchase order of a Learning Management System (LMS) course for at least one student, said method comprising:
creating a course data file comprising at least one course record stored in a database coupled to the computer system, wherein a course record of said at least one course record comprises a sale course code and a delivery course code, the sale course code representing a learning management system (LMS) course in the purchase order, said delivery course code representing the LMS course in a training session as provided by a LMS server;
generating an order data file comprising at least one applicant order, said at least one applicant order comprises the purchase order, wherein an applicant order of said at least one applicant order comprises a sale course code, a manager e-mail address, and a quantity, the sale course code representing the LMS course purchased by the applicant order, the manager e-mail address representing an e-mail address of a manager of said at least one student, the quantity representing a number of licenses to attend the LMS course that is purchased by the applicant order, wherein the applicant order is mapped to the course record in the course data file, wherein a first value of the sale course code of the applicant order is identical to the sale course code of the mapped the course record;
producing an access code for the applicant order, the access code enabling said at least one student to interactively enroll in the LMS course; and
communicating the access code to the manager e-mail address of the applicant order such that the access code is forwarded to said at least one student.

12. The computer system of claim 11,
wherein the database comprises a Learning Management System (LMS) database, a learner portal database, and an internal order database,
wherein the LMS database stores said at least one course record, at least one student record, and at least one order record, said at least one student record respectively corresponding to said at least one student, wherein an order record of said at least one order record corresponding to the applicant order is stored in the LMS database,
wherein the learner portal database stores a respective user record corresponding to each student of said at least one student, the respective user record being uniquely identified by a respective user ID identical to a respective student e-mail address of said each student record, wherein the respective student e-mail address is registered by use of the access code,
wherein the internal order database stores at least one internal order record comprising the applicant order and a history log, each internal order record corresponding to a respective order record of said at least one order record stored in the LMS database based on the sale course code of the applicant order, the history log storing the applicant order upon successful completion of said producing the access code, and
wherein the LMS database, the learner portal database, and the internal order database are periodically synchronized by a database server.

13. The computer system of claim 11, wherein the sale course code of the course record corresponds to the delivery course code of the course record such that the sale course code of each Learning Management System (LMS) course provided by the LMS server stores a circumstance of the purchase transaction, wherein the circumstance is selected from the group consisting of specifics of discount applied to the purchase transaction, a country from which the purchase transaction originates, and combinations thereof.

14. The computer system of claim 11, said producing the access code comprising:
ascertaining that the quantity of the applicant order is greater than one (1), which indicates that the applicant order was made for at least two students;
ascertaining that the manager e-mail address of the applicant order is a valid e-mail address of the manager of said at least two students;
rendering the access code based on inputs from an administrator of the LMS server, wherein the access code associates the quantity of the applicant order with the LMS course, the quantity of the applicant order being decreased by one (1) upon each interactive enrollment of an individual student in the LMS course, wherein said each interactive enrollment is selected from the group consisting of registration with the LMS server, enrollment in the LMS course, and combinations thereof;
creating an order record corresponding to the applicant order within the database; and
writing the applicant order in a history log of successfully processed orders within the database.

15. The computer system of claim 11, said producing the access code comprising:
ascertaining that the quantity of the applicant order is one (1), which indicates that the applicant order was made for an individual student;
ascertaining that a student e-mail address of the applicant order is null and that the manager e-mail address of the applicant order is a valid e-mail address of the manager of the individual student;
rendering the access code based on inputs from an administrator of the LMS server, wherein the access code associates the quantity of the applicant order with the LMS course, the quantity of the applicant order expiring upon an interactive enrollment of the individual student in the LMS course, wherein the interactive enrollment is selected from the group consisting of registration with the LMS server, enrollment in the LMS course, and combinations thereof;
creating an order record corresponding to the applicant order within the database; and
writing the applicant order in a history log of successfully processed orders within the database.

16. A process for supporting computer infrastructure, said process comprising providing at least one support service for at least one of creating, integrating, hosting, maintaining, and deploying computer-readable code in a computing system, wherein the code in combination with the computing system is capable of performing a method for optimizing process of a purchase order of a Learning Management System (LMS) course for at least one student, said method comprising:
creating a course data file comprising at least one course record stored in a database coupled to the computer system, wherein a course record of said at least one course record comprises a sale course code and a delivery course code, the sale course code representing a learning management system (LMS) course in the purchase order, said delivery course code representing the LMS course in a training session as provided by a LMS server;
generating an order data file comprising at least one applicant order, said at least one applicant order comprises the purchase order, wherein an applicant order of said at least one applicant order comprises a sale course code, a manager e-mail address, and a quantity, the sale course code representing the LMS course purchased by the applicant order, the manager e-mail address representing an e-mail address of a manager of said at least one student, the quantity representing a number of licenses to attend the LMS course that is purchased by the applicant order, wherein the applicant order is mapped to the course record in the course data file, wherein a first value of the sale course code of the applicant order is identical to the sale course code of the mapped the course record;
producing an access code for the applicant order, the access code enabling said at least one student to interactively enroll in the LMS course; and
communicating the access code to the manager e-mail address of the applicant order such that the access code is forwarded to said at least one student.

17. The process of claim 16,
wherein the database comprises a Learning Management System (LMS) database, a learner portal database, and an internal order database,
wherein the LMS database stores said at least one course record, at least one student record, and at least one order record, said at least one student record respectively corresponding to said at least one student, wherein an order record of said at least one order record corresponding to the applicant order is stored in the LMS database,
wherein the learner portal database stores a respective user record corresponding to each student of said at least one student, the respective user record being uniquely identified by a respective user ID identical to a respective student e-mail address of said each student record, wherein the respective student e-mail address is registered by use of the access code,
wherein the internal order database stores at least one internal order record comprising the applicant order and a history log, each internal order record corresponding to a respective order record of said at least one order record stored in the LMS database based on the sale course code of the applicant order, the history log storing the applicant order upon successful completion of said producing the access code, and
wherein the LMS database, the learner portal database, and the internal order database are periodically synchronized by a database server.

18. The process of claim 16, wherein the sale course code of the course record corresponds to the delivery course code of the course record such that the sale course code of each Learning Management System (LMS) course provided by the LMS server stores a circumstance of the purchase transaction, wherein the circumstance is selected from the group consisting of specifics of discount applied to the purchase transaction, a country from which the purchase transaction originates, and combinations thereof.

19. The process of claim 16, said producing the access code comprising:
ascertaining that the quantity of the applicant order is greater than one (1), which indicates that the applicant order was made for at least two students;
ascertaining that the manager e-mail address of the applicant order is a valid e-mail address of the manager of said at least two students;
rendering the access code based on inputs from an administrator of the LMS server, wherein the access code associates the quantity of the applicant order with the LMS course, the quantity of the applicant order being decreased by one (1) upon each interactive enrollment of an individual student in the LMS course, wherein said each interactive enrollment is selected from the group consisting of registration with the LMS server, enrollment in the LMS course, and combinations thereof;
creating an order record corresponding to the applicant order within the database; and
writing the applicant order in a history log of successfully processed orders within the database.

20. The process of claim 16, said producing the access code comprising:
ascertaining that the quantity of the applicant order is one (1), which indicates that the applicant order was made for an individual student;
ascertaining that a student e-mail address of the applicant order is null and that the manager e-mail address of the applicant order is a valid e-mail address of the manager of the individual student;
rendering the access code based on inputs from an administrator of the LMS server, wherein the access code associates the quantity of the applicant order with the LMS course, the quantity of the applicant order expiring upon an interactive enrollment of the individual student in the LMS course, wherein the interactive enrollment is selected from the group consisting of registration with the LMS server, enrollment in the LMS course, and combinations thereof;
creating an order record corresponding to the applicant order within the database; and
writing the applicant order in a history log of successfully processed orders within the database.
